(19) United States
(12) Patent Application Publication
(10) Pub. No.: US 2002/0011148 A1
(43) Pub. Date: Jan. 31, 2002

(54) Axial actuator

(76) Inventor: Dietmar Weissflog, Rheda-Wiedenbruck (DE)

Correspondence Address: Michael Best & Friedrich LLP, Suite 360, 3773 Corporate Parkway, Center Valley, PA, 18034-8217, US

(21) Appl. No.: 09/864,643

(22) Filed: May 24, 2001

(30) Foreign Application Priority Data
May 25, 2000 (DE) 100 25 978.2

(51) Int. Cl. F15B 11/08

(52) U.S. Cl. 91/418

(57) ABSTRACT

Axial actuator for converting a rotary motion into a translational motion, in particular for controlling the axial position of variator disks of an infinitely variable vehicle transmission (continuously variable transmission or CVT), which has the following features: a shaft, a control element, which is fixed axially relative, to the shaft, can be rotated about the axis of the shaft by means of a driving device and has a rear end and a front end, with a linear-motion element, which is mounted rotatably relative to the control element, is fixed in terms of rotation relative to the shaft and has a rear end and a front end, with a flanged cage, which is arranged between the control element and the linear-motion element, preferably carries rolling-contact elements and has spiral flanges, at least three concentric, spirally or helically rising ramps facing the rear end of the linear-motion element being arranged at the front end of the control element, and at least three concentric ramps, which face the front end of the control element, rise spirally or helically and are complementary to the ramps, being arranged at the rear end, of the linear-motion element, the spiral or helical shape of the flanges corresponding to the spiral shape of the ramps and, a pressure face for transmissing axial forces being arranged at the front end of the linear-motion element.

### BACKGROUND OF THE INVENTION

The present invention relates to an axial actuator, for converting a rotary motion into a translational motion, in particular for controlling the axial position of variator disks of an infinitely variable vehicle transmission (continuously variable transmission or CVT), to a variator and to a CVT.

International Patent Application WO/00/03157 has disclosed an axial actuator with at least one first pair of spiral tracks which extend in such a way as to be rotatable along the lateral surface of a cylinder about an axial axis, there being arranged between the first pair of spiral tracks a radially guided axial needle or roller ring, the running length of which corresponds essentially to the length of the tracks. In a variation of this embodiment, a second pair arranged offset relative to the first pair of spiral tracks is provided to eliminate transverse forces and achieve as high tipping stability as possible. However, an axial actuator constructed in this way is not very suitable for transmitting high or very high axial forces.

German Patent DE 199 42 462 C1 shows an axial actuator having an intermediate member having two adjuster rings with at least three pairs of helical raceways mutually movable against each other, characterized by at least three interconnected distance members arranged between the two adjuster ring, the distance members following the form of the helical raceways and reducing the friction between the two adjuster rings, whereas a rotation of one adjuster ring causes an axial movement of the other adjuster ring.

The foregoing illustrates limitations known to exist in present devices and methods. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

It is therefore an object of the present invention to propose an axial actuator for high and extremely high axial loads which can still be operated with an economical use of energy. The inventor has furthermore set himself the object of proposing an axial actuator of this kind accommodated in a variator of a continuously variable transmission, and a continuously variable transmission of this kind per se.

The object is achieved by an axial actuator in accordance with claim 1.

By means of the configuration, in accordance with the invention, of an axial actuator with at least three ramps, which run concentrically around an axial axis, it is possible to create an arrangement which is very uniform and absolutely stable in terms of tipping. A flanged cage placed between the two mutually complementary ramp groups, carrying spiral flanges and having rolling-contact elements, which are preferably arranged in the central area of the spiral flanges, allows absolutely reliable and repeatable actuation of the axial actuator. This applies particularly to high axial forces since, in contrast to the axial actuators known from the prior art, a large transmission area for axial forces is obtained without the unit surface pressure being too high.

In an advantageous embodiment of the invention, the axial actuator is, in accordance with claim 2, constructed with a driving device for the rotatable control element. The configuration of the driving device as a multi-chamber pump to be found here increases the efficiency of the axial actuator in an advantageous manner while using a very small, spaced-saving pump which can operate at a low oil pressure with a small quantity of oil. Moreover, gentle, jolt-and jerk-free and, at the same time, accurately definable actuation of the linear motion element is possible in a short response time. Claim 3 describes a variator for a CVT with an axially adjustable variator disk mounted on a shaft and having longitudinal pressurized-oil holes which, via radial holes, supply an annular slot from which, in turn, radial holes lead into pressure chambers of the driving device. This refinement is a very elegant solution to the supply of energy to the driving device and its chambers, which can be achieved within the minimum of space and with a very small number of components.

The advantageous embodiments of a variator according to the invention which are described in claims 4 and 5 relate to the axially displaceable arrangement of the variator disk on the shaft by means of splines or a crossed-roller bearing arrangement. One or other construction will be preferred depending on the particular goals of the application, a decision being taken as to whether a sliding- or a rolling-friction version is the more advantageous in any particular application.

In an advantageous refinement of the invention, the axial actuator claimed, accommodated in a variator, is doubled in number for use in operating a CVT in accordance with claim 6. Here, it is ensured, inter alia by subjecting the output-side variator to a torsion spring that presses the loose disk against the fixed disk of the variator, that at the moment when an energy drop occurs on the input side, the loose disk on the output side is moved into the forwardmost position under spring control.

Further advantages and features of the configurations according to the invention can be found in the following description, in which an exemplary embodiment of the invention is outlined briefly with reference to drawings to allow a better understanding of the invention.

### BRIEF DESCRIPTION OF THE DRAWINGS

FIG. 1 shows a section through two variators of a continuously variable transmission (CVT) in a sectional representation, the two variators being oriented toward one another and each accommodating an axial actuator according to the invention;

FIG. 2 shows the input-side (upper) variator from FIG. 1 in section on a somewhat larger scale;

FIG. 3 shows the output-side (lower), variator from FIG. 1 in section on a somewhat larger scale;

FIG. 4 shows a variator similar to that in FIG. 3, although a so-called crossed-roller bearing arrangement is used here instead of splines between the shaft and the looser disk;

FIG. 5 shows a section through the input-side variator, as seen in the direction of arrow C in FIG. 1;

FIG. 6 shows a section through the output-side variator as seen in the direction of arrow C in FIG. 1;

FIG. 6a shows an illustration which is identical to the illustration in FIG. 6, with the exception that a crossed-roller bearing arrangement has been shown instead of splines (cf FIG. 4);

FIG. 7 shows a section through the input-side variator arrangement as viewed in the direction of arrow B in FIG. 1;

FIG. 8 shows a section through the output-side variator arrangement as viewed in the direction of arrow B in FIG. 1;

FIG. 9 shows a section through the input-side variator, in particular through the pressure chambers of the driving device in accordance with arrow D in FIG. 1;

FIG. 10 shows a section through the output-side variator viewed in direction D in FIG. 1;

FIG. 11 like FIG. 1, shows the variators of a CVT, but instead of showing them in section, shows them as encapsulated with the loose disks retracted to the maximum possible extent;

FIG. 12 shows the arrangement of the two variators of a CVT in accordance with FIG. 1, as seen in direction E in FIG. 11;

FIG. 13 gives a schematic representation of some of the components of variator VI without the housing;

FIG. 14 gives a schematic view of a rolling contact element for a crossed-roller bearing arrangement;

FIG. 15 gives a schematic view of another rolling contact element for a crossed-roller bearing arrangement; and

FIG. 16 gives a schematic view of a flanged cage in perspective representation.

### DETAILED DESCRIPTION

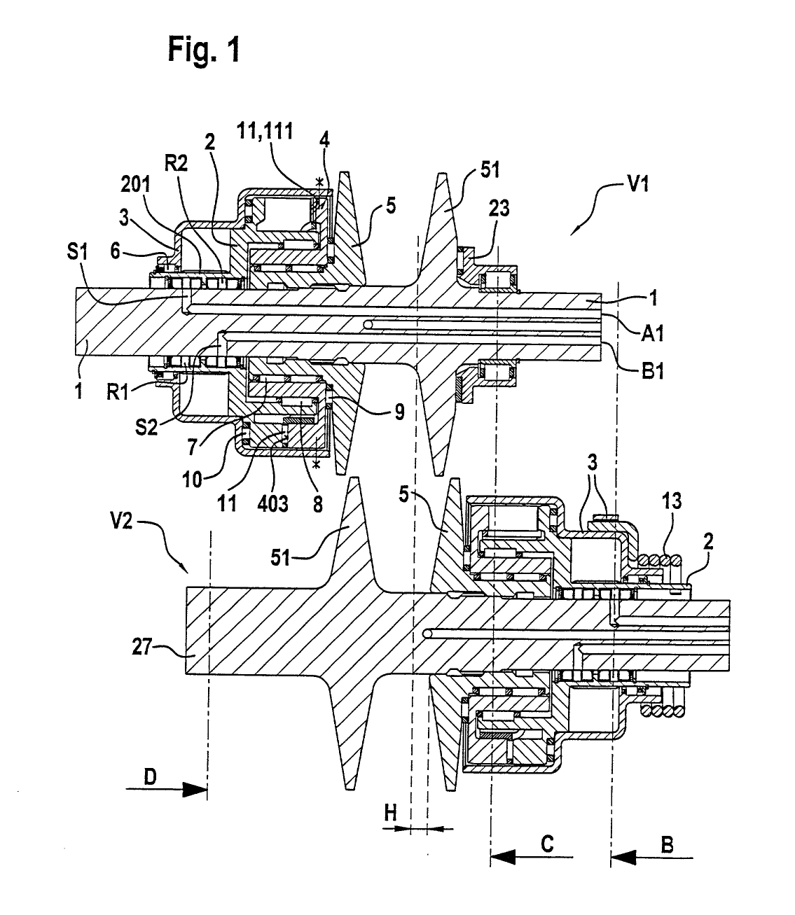

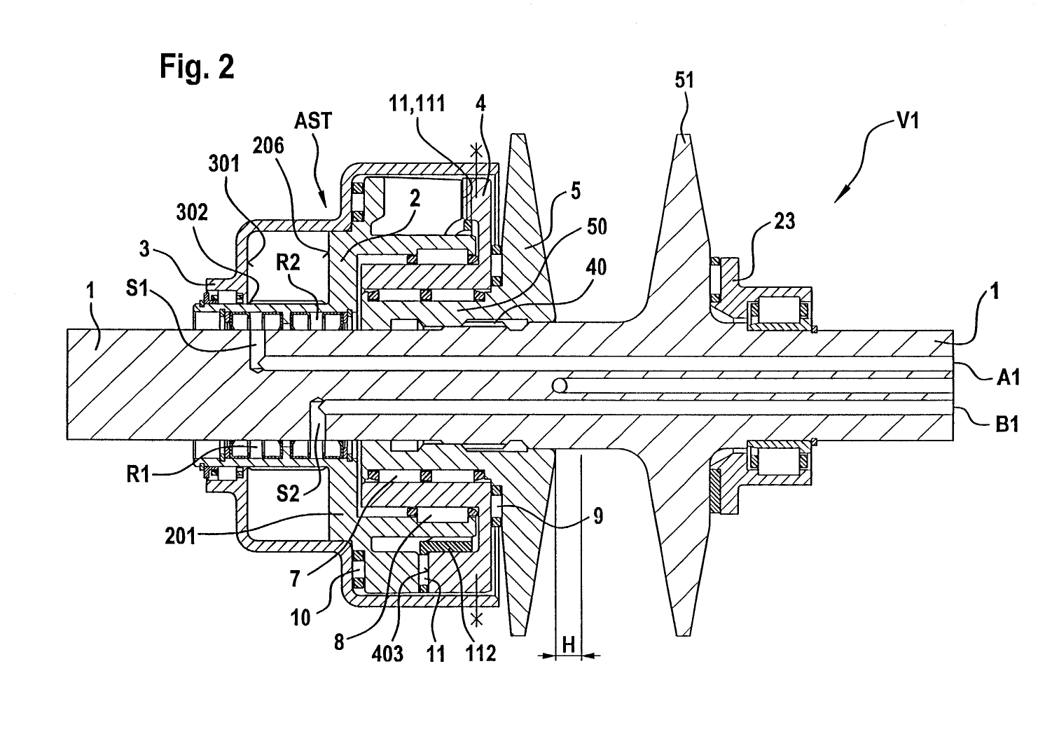

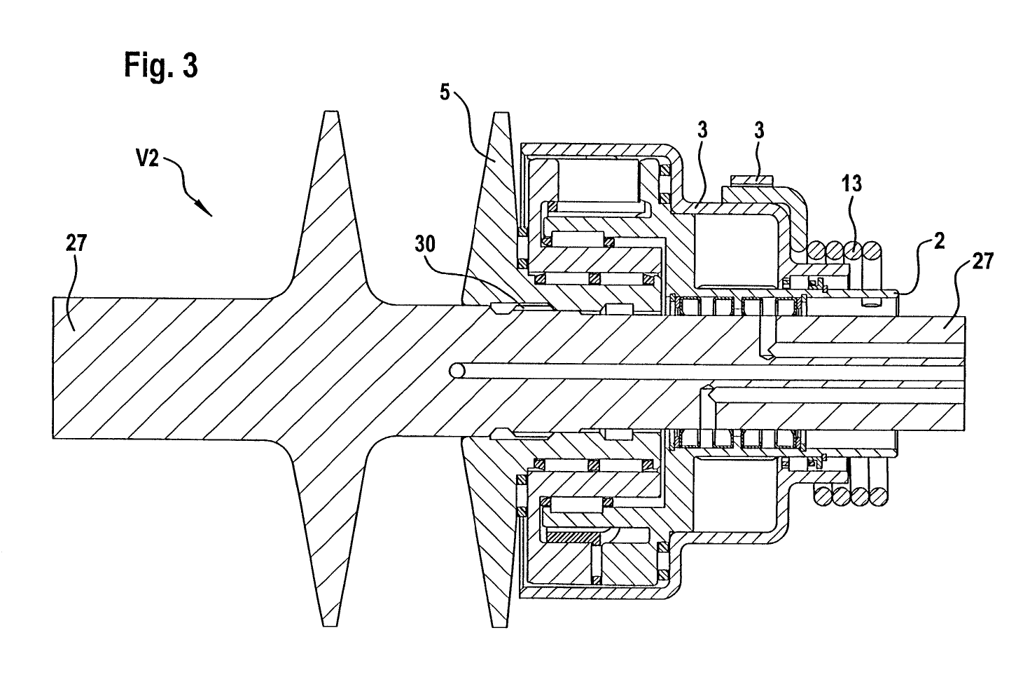

FIG. 1 shows two variators V1 and V2, which are shown arranged in the installed position relative to one another. (Technically identical or similar components of the two variators V1 and V2 are identified by the same reference numerals to simplify the description). The input-side variator V1 is shown at the top in FIG. 1 and FIG. 2. The output side variator V2 can be seen at the bottom in FIG. 1 and FIG. 3. A shaft 1, horizontal in FIG. 2, is here of onepiece construction with a variator disk 51, which lies opposite a variator disk 5 (loose disk) to the left of it. The variator V1 is supported axially and radially in the same gear case (not shown) by means of a bearing arrangement 23 and a housing 3. The same applies to variator V2, components 3 and 23 being shown only in part in the figures for the sake of clarity.

At this point, it should be stated that it has been assumed that continuously variable transmissions are known from the literature, in particular from an article by Dr.-Ing. Hartmut Faust and Dr. Ing. Andre Linnenbrucker entitled “Development of Continuously Variable Transmmissions at LuK”:

For this reason, the technology and details or particular features of continuously variable transmissions will not be repeated here. Three further literature references may also be mentioned here:

(1) Dr. techn. R. Fischer, Dipl.-Ing. D. Otto:

Wandleruberbruckungssysteme (converter lock-up systems); 4^{th} international LuK symposium 1994, “Leichter Schalten umweltfreundlicher und komfortabler Fahren” (Easier gear changing, more comfortable and environmentally friendly driving); pp 133ff.

(2) Dr. techn. R. Fischer:

Das TorCon-System—Ein neues Wandleruberbruckungskonzept als Beitrag zur Okonomie und Fahrtfreude (The TorCon System

A new converter lock-up concept as a contribution to economy and driving pleasure): VDI Report No. 1175, “Getriebe in Fahrzeugen 1995” (Vehicle Transmissions) pp 301 ff.

(3) Dave Piper:

Automatic Transmissions—An American Perspective; VDI Report No. 1175, “Getriebe in Fahrzeugen 1995” (Vehicle Transmissions), pp 25 ff.

The axial component of the contact force, which is transmitted by the loose disk 5 and a chain (not shown) that moves between the cones of the disks 5 and 51, is taken by a radial/thrust bearing 23, which is mounted in a fixed position on a gear case (not shown) and supports the fixed disk 51 and the shaft 1 on the left. To adjust the distance between the loose disk 5 and the fixed disk 51, the loose disk 5 is moved axially toward the fixed disk 51. This is accomplished by means of an axial actuator AST with a linear-motion element 4, relative to which the loose disk 5 is rotatably arranged and which transmits the axial force for the adjustment of the loose disk 5 via a thrust bearing 9 situated between the linear-motion element 4 and the loose disk 5. As can be seen from FIG. 1 and FIG. 2, the loose disk 5 is of one-piece construction with an axial sleeve 50, which, on the outside, engages in splines 40 on the shaft 1 and, on its outside, guides the linear-motion element 4 radially by means of a radial bearing 7. The linear-motion element 4, which is provided with three ramps 403, is controlled via flanges 111 of a flanged cage 11 that rest against the ramps 403 and, for their part, contain rolling-contact elements, by ramps 203 of a control element 2, which are complementary to the ramps 403, said control element being guided radially on the outer circumference of the linear-motion element 4 by means of a bearing 8 (see also FIGS. 6 and 6a). A flanged cage of this kind has been described, for example, in the as-yet unpublished German Patent Application 199 42 462.4. The control element 2 is supported by a thrust bearing 10 on a housing 3. The housing 3 is supported radially against a rear, externally cylindrical end 201 of the control element 2 by a radial bearing 6. The rear end 201 of the control element 2 contains annular slots RI and R2, which are open toward the shaft 1 and are aligned with radial holes S1 and S2 respectively, these in turn being supplied with pressurized oil by longitudinal pressurized-oil holes A1 and B1 respectively in order to control the axial actuator AST described here in the manner described below.

To make the axial actuator to be described easier to understand, a brief explanation will be given of the way in which the continuously variable transmission illustrated in FIG. 1 operates. An engine, which imparts rotation to the shaft in order to supply power, may be imagined at the left-hand end of the shaft of the upper variator VI. This power is to be transmitted to the shaft 27 of the lower variator V2.

Transmission is accomplished by means of a V-belt (not shown here) or a corresponding chain with a variable radius of warp depending on the distance between the fixed and loose disks 51 and 5 of the variators.

In actual fact, the position of the chain disks 51 and 5 of the two variators Vi and V2 shown in FIG. 1 does not correspond to any operating position since the two disks are at the maximum spacing here. In reality, the disks move axially backward and forward by a distance H (FIG. 1). To set the configuration in FIG. 1 for start-up, i.e., the lowest ratio of torque transmission from variator VI to variator V2 and from shaft 1 to shaft 27, the loose disk 5 of, the variator V2 must be imagined as having been displaced to the left by distance H. In this position, a transmission chain would have the least amount of wrap on variator V1 and the greatest amount of wrap between the disks 51 and 5 of the variator V2 on shaft 27. In this case, it would therefore be a reduction ratio.

To change the transmission ratio to a speed-increasing ratio, the disks 5 must be moved toward the disks 51 up to a maximum distance H until, in the extreme case, the radii of wrap are precisely the reverse of those described above.

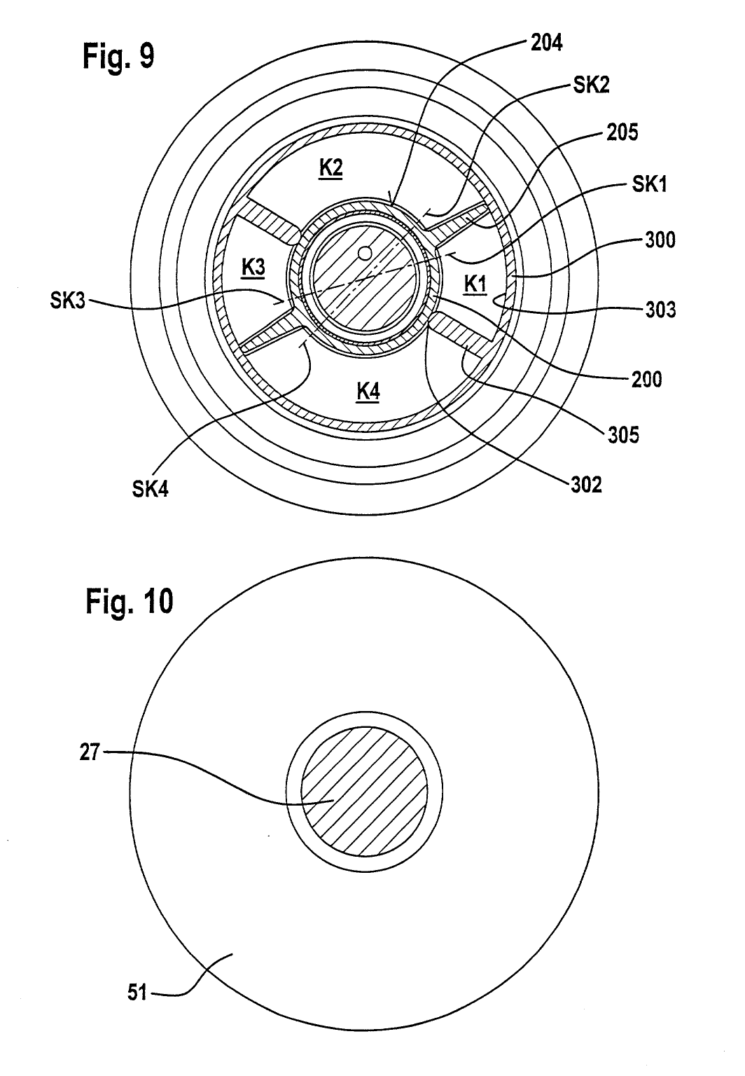

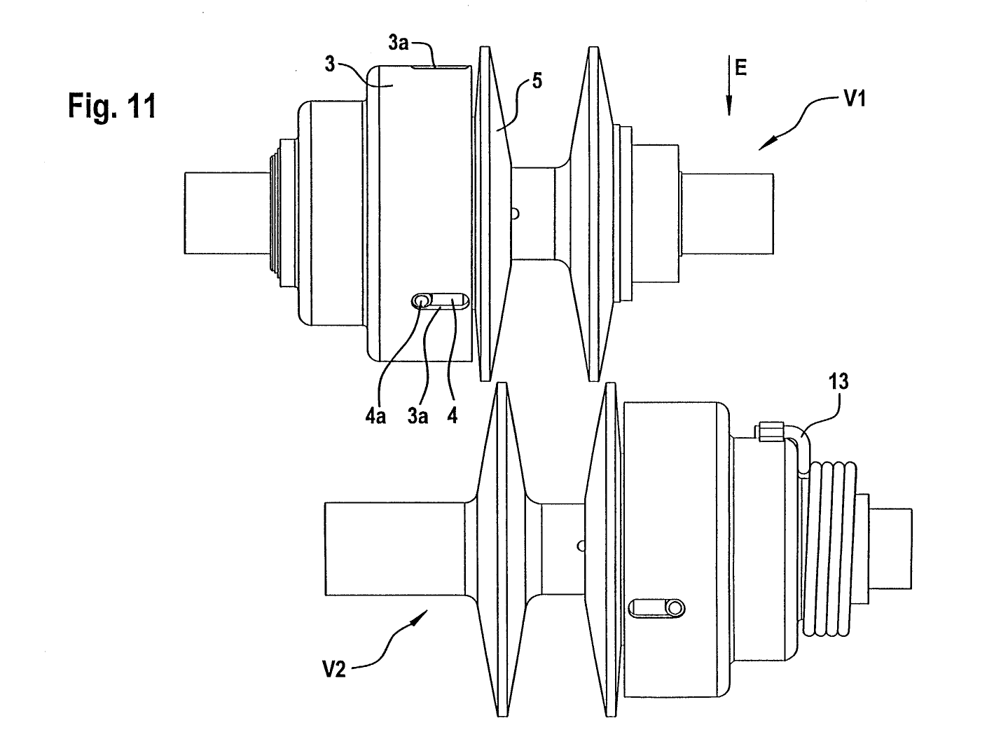

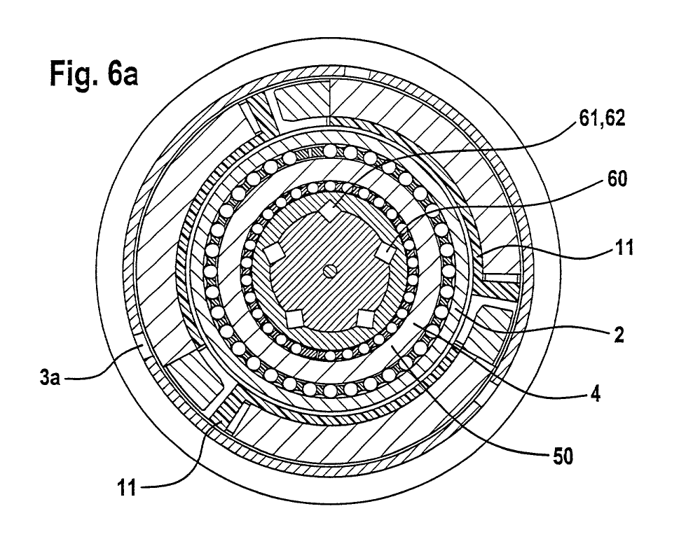

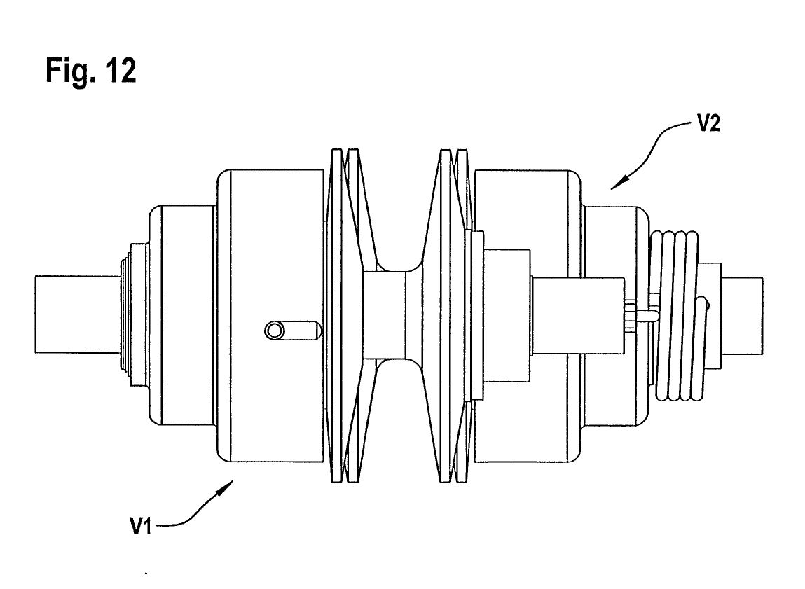

To displace a loose disk 5 of a variator, an axial actuator AST is controlled as follows (this will be easier to understand if the apparatus is considered in a static condiiton, i.e., shaft 1 and shaft 27 are thought of as not rotating): pressurized oil is pumped via a longitudinal pressurized-oil hole A1 and a radial hole S2 into an annular slot R1 arranged in the rear end of the control element 2 and pointing toward the shaft 1, this slot communicating with the chambers K1 and K3 of the driving device P (see FIG. 9). An annular slot R2 communicating with the chambers K2 and K4 is supplied with pressurized oil in a similar manner via a longitudinal pressurized-oil hole B1 and a radial hole S2. The chambers K1-K4 are formed by two axially nested concentric housing halves 300 and 200, the outer housing half 300 having an end 301 with a central round aperture 302, a cylindrical wall 303 extending axially from the end 301 to the control element 2, and two chamber walls 305 extending radially inward from the wall 303 to the round aperture 302. The inner housing half 200 contains a cover ring 206, which extends radially inward essentially from the cylindrical wall 303 to the central round aperature 302. A cylindrical wall 204 of the control element 2 extends axially from the cover ring 206 to the aperture 302. Extending radially from the cylindrical wall 204 of the inner housing half 200 to the cylindrical wall 303 are outward-pointing chamber walls 205, which are offset by 180° and form a leaktight seal with the cylindrical wall 303. Two mutually opposite chamber walls 305 extend from the cylindrical wall 303 of the outer housing half 300 to the cylindrical wall 204 of the inner housing 200. This gives four separate chambers K1 to K4 (in variator V1), the chamber pair K1 to K3 and the chamber pair K2 and K4 each communicating with one another via annular slots R1 and R2. If pressurized oil is now supplied via the pressurized oil hole A1, the volume of the chamber K1 and the chamber K3 is necessarily increased. This is accomplished by virtue of the fact that the pressure increase in the chambers K1 and K3 causes a force to be exerted on the chamber walls 205, as a result of which—the pressurized oil being supported against the chamber walls 305, which are fixed relative to the transmission—the control element 2 (as seen in FIG. 9) is rotated in the counterclockwise direction. The chamber walls 205 serve, as it were, as turbine blaues or pump vanes.

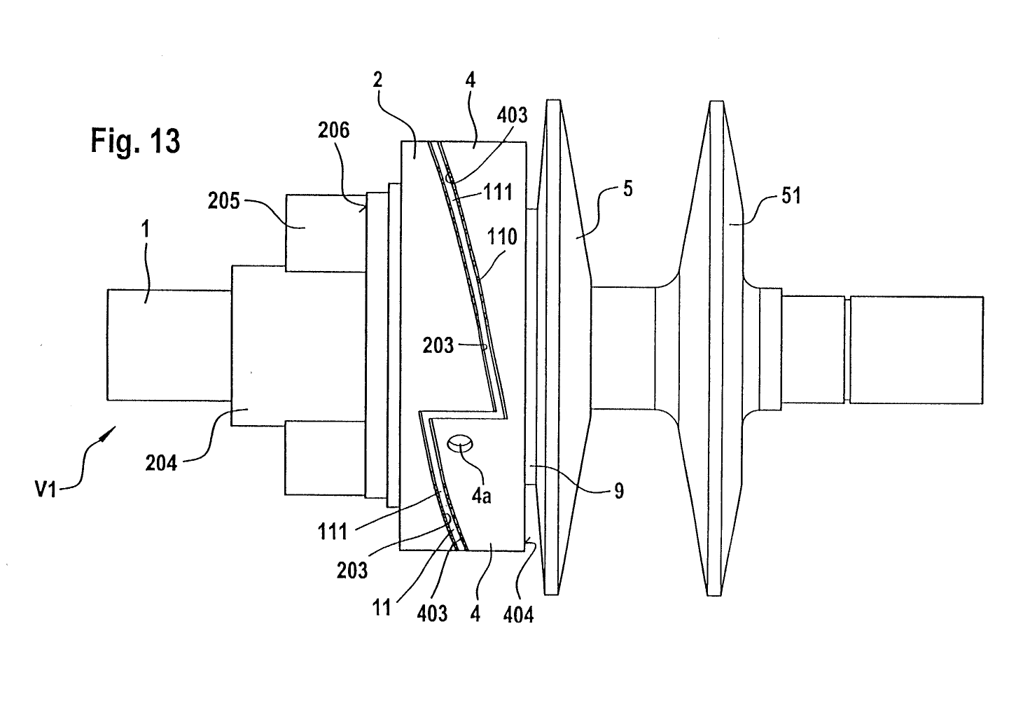

Rotation of the control element 2 relative to the housing 3—initiated by the supply of pressurized oil via the hole A2 as just described—reduces the volume of pressurized oil in the chambers K3 and K4, which carry oil away again by means of the longitudinal pressurized-oil hole B1 via an annular slot R2 and radial hole S2. A detailed description of the supply and discharge of pressurized oil will not be given here since this will be available to a person skilled in the art from conventional pressurized-oil control systems. As outlined in FIG. 11 and also in FIG. 2, the linear-motion element 4 is fixed in terms of rotation but not in terms of axial motion relative to the housing 3. For example, the linear-motion element 4 is mounted in a manner fixed in terms of rotation relative to housing 3 by means of retention pins 4a, which are mounted on the circumference of the linear-motion element 4 and pass through longitudinal slots 3a formed in the housing 3. Rotation of control element 2 about the axis of the shaft 1 has the effect that ramps 203 arranged on the control element 2 and rising toward the linear-motion element 4 cause the linear-motion element, which can, of course, not rotate with the rotating control element 2, to move to the right. For this purpose, the linear-motion element has ramps 403 that are complementary to the ramps 203 and likewise rise in a spiral. To ensure that the two ramp groups 203 and 403 do not rest upon one another as a sliding pair, a flanged cage 111 is arranged between them, its spiral flanges 111, of which there are three in this case and which preferably carry rolling-contact elements, thus forming a spiral thrust bearing. As can be seen from FIGS. 9 and 8, the adjustment angle to obtain the axial adjustment of the loose disk 5 by the distance H is about 700. However, precise relative dimensions will not be given here. The specific dimensions depend on the specific requirements. To simplify the shape and position of the components just described, said shape and position being somewhat complicated to describe, some of the relevant components described are shown again in schematic representation in FIG. 13, the housing 3 with its outer housing half 300 not being shown in this case for reasons of clarity. As a result, the shape of the inner housing half 200 can be clearly seen. However, it can be clearly seen from FIG. 13 how the control element 2 with its ramps 203 and the linear-motion element 4 with its spiral ramps 403 are positioned relative to one another. The flanged cage 11 between them, with flanges 111 which are likewise of spiral configuration, carries rolling-contact elements 110, for example. The flanges 111 of the flanged cage 11 are connected to one another at the circumference by a cylindrical part-sleeve 112 (FIG. 2), it likewise being possible for the cylindrical sleeve 112 to carry rolling contact elements (not shown) to provide radial support for the flange cage 11 relative to the control element 2 and/or the linear-motion element 4.

With the arrangement according to the invention of axial actuators in variators of a CVT as just described it is possible to create a highly economical arrangement, the advantages obtained by means of the present invention being very extensive. The design allows high efficiency with a high transmission ratio and a low energy requirement. Compared with known continuously variable transmissions, only a tenth to a fifth of the energy consumption required there is employed. The construction of the driving device with pressure chambers requires only a small pump, which operates at a low oil pressure with a small quantity of oil, and the variator has no rotating parts. Fast adjustment of the variator is promoted if oil flowing out of chambers K1 and K3 is fed immediately to chambers K2 and K4.

A helical spring 13 is shown on the shaft 27 illustrated at the bottom in FIG. 1 and in FIG. 3, this spring being secured in the housing 3, on the one hand, and in the control element 2, on the other hand, with the result that the two elements, namely the control element 2 and tbe housing 3, have an inbuilt preload relative to one another and thus adjust the chambers K1 to K4 and the position of the loose disk 5 in such a way that the distance between the loose disk 5 and the fixed disk 51 is minimal when operation is interrupted on the oil pressure supply side, e.g. because the engine has stalled or there is a power failure. If there is assisted onward rotation of the shafts 1 and 27 or the entire transmission unit, a speed-increase or speed-reduction ratio favorable for restarting is thus automatically established.

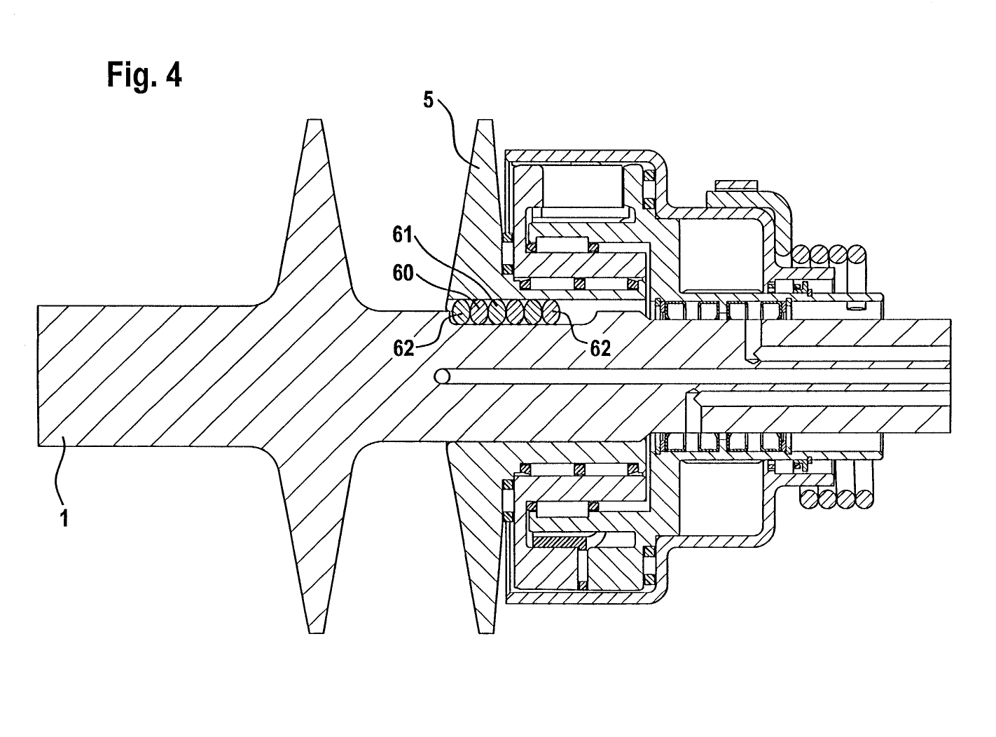

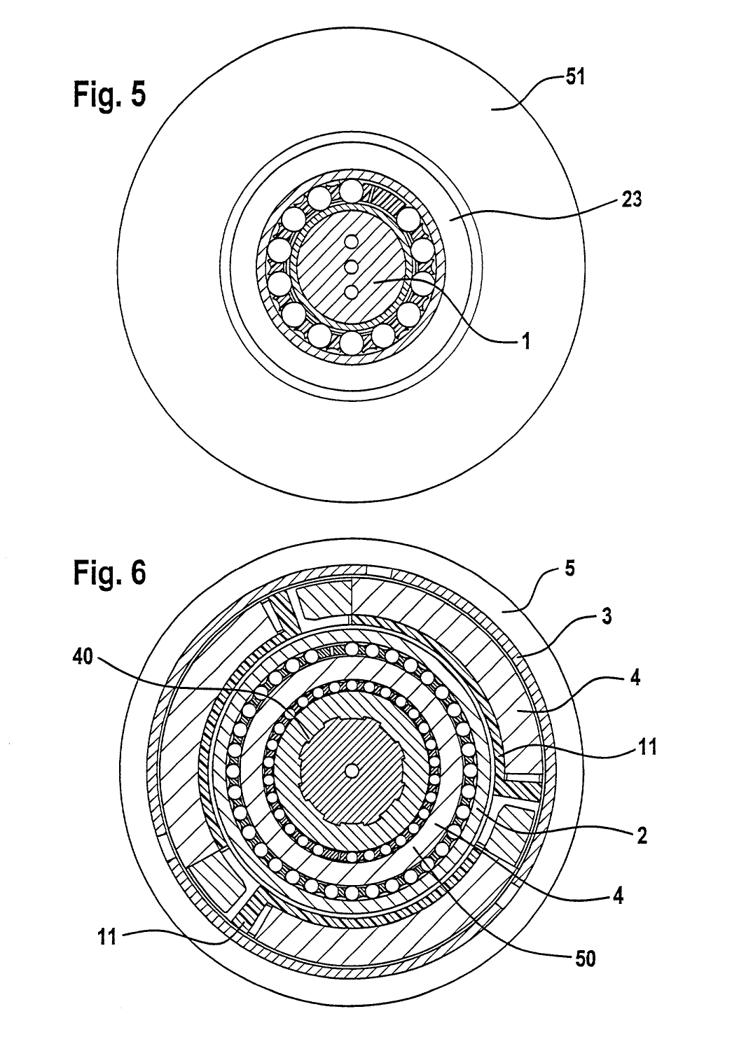

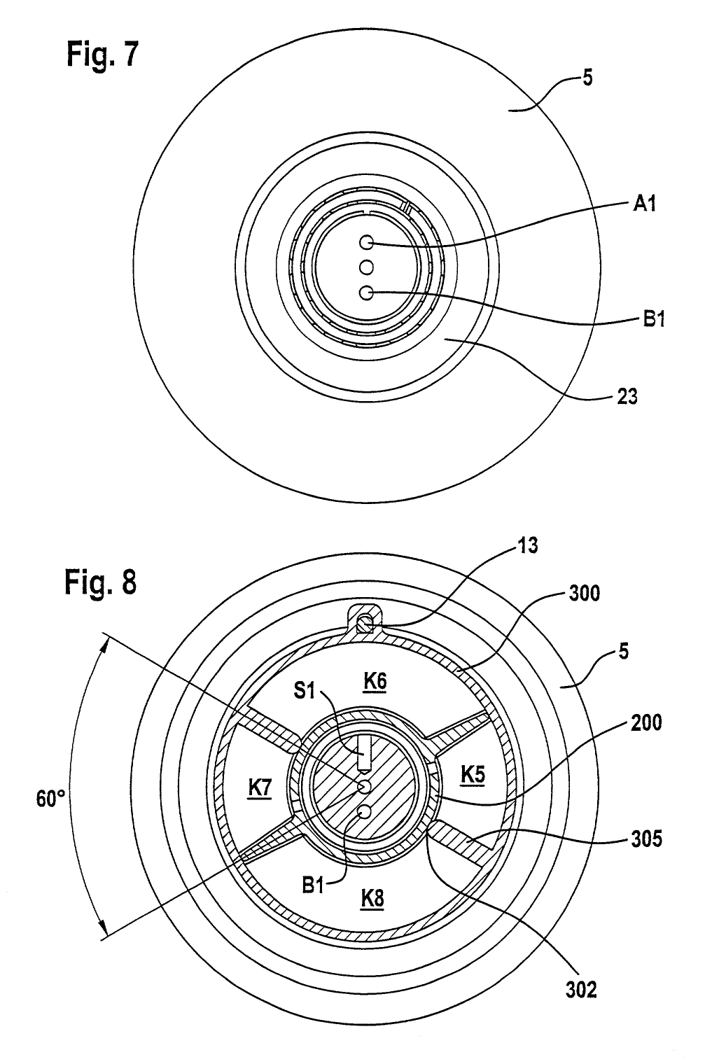

FIGS. 4 and 6a show a special form of an axially displaceable but rotationally fixed support coupling between, the loose disk 5 and the shaft 1. This is a so-called crossed-roller bearing arrangement 60. In this arrangement, grooves are arranged longitudinally on the circumference of the shaft and in the variator disk, and cylindrical rollers 61 are placed crosswise in these grooves. This allows symmetrical torque transmission from the loose disk to the chain (not shown).

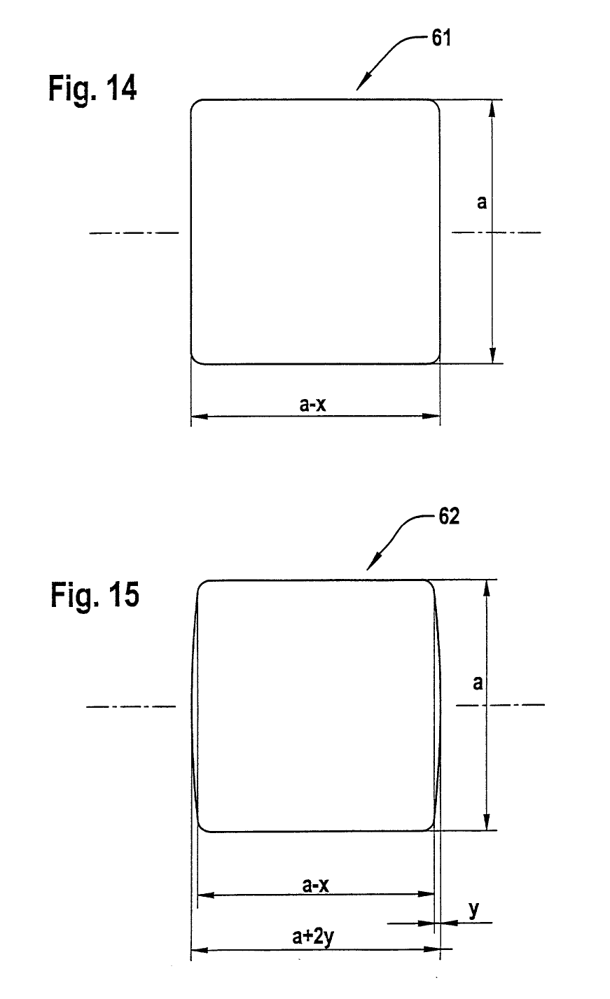

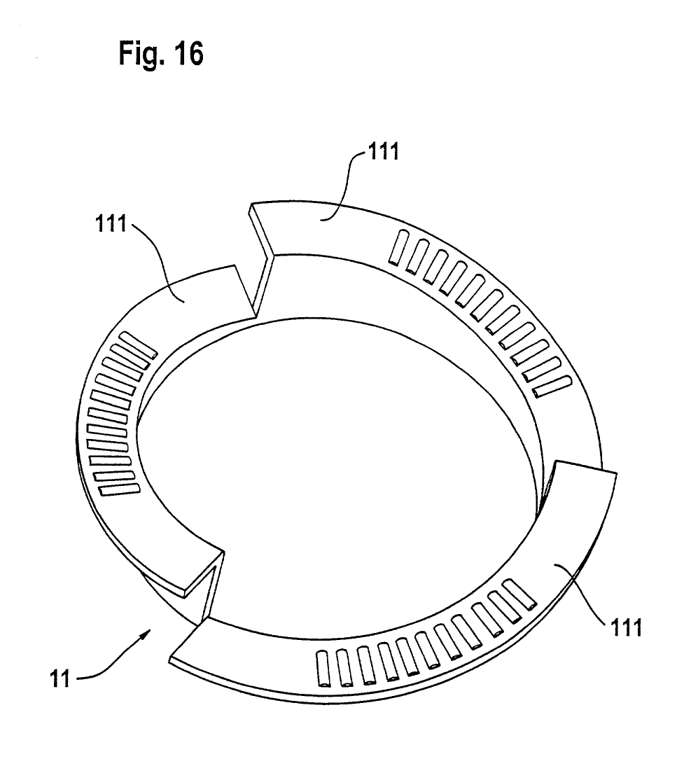

FIG. 14 shows a rolling-contact element 61, and cylindrical roller with a diameter A and a height A-X. This makes the diameter of the rolling-contact element 61 greater than its length. Since the rolling-contact elements 61 roll axially in grooves and there are no intermediate elements (cages and the like) between the rolling-contact elements 61, the rolling contact elements must be fixed in their end positions or in the instantaneous positions. This is advantageously possible when all or at least the first and the last rolling-contact element 62 (see FIG. 15) have a height which is greater than their diameter, e.g. a height A+2Y. This is not expensive and can be achieved simply by coating the rolling-contact element 62. If, for example, a plastic coating is applied, this gives a material which is softer than the rolling-contact element itself and hence flexible and, furthermore, is rougher than the rolling-contact element itself. When installed, the flexible region is compressed. If there are no translational forces acting, the rolling-contact elements are held in their position by means of the coated end faces, whatever their position. The length of the grooves and the number of rolling-contact elements are matched to the respectively required stroke (displacement distance H for the loose disk 5). The number of grooves (5 in the example shown) depends on the intended quality of axial guidance and thrust torque to be transmitted. This results in an astonishingly simple but very advantageous shaft/hub connection, which operates with very little wear and very reliably.

The exemplary embodiments explained in this description do not limit the scope of protection of the present application. Analogous modifications likewise form part of the subject matter of the present application.

Having described the invention, what is claimed is:

1. Axial actuator for converting a rotary motion into a translational motion, in particular for controlling the axial position of variator disks of an infinitely variable vehicle transmission (continuously variable transmission or CVT), having the following features:
a) a shaft;
b) a control element, which is fixed axially relative to the shaft, can be rotated about the axis of the shaft by means of a driving device and has a rear end and a front end;
c) a linear-motion element, which is mounted rotatably relative to the control element, is fixed in terms of rotation relative to the shaft and has a rear end and a front end;
d) a flanged cage, which is arranged between the control element and the linear-motion element, preferably carries rolling-contact elements and has spiral (or helical) flanges;
at least three concentric, spirally or helically rising ramps facing the rear end of the linear-motion element being arranged at the front end of the control element, and at least three concentric ramps, which face the front end of the control element, rise spirally or helically and are complementary to the ramps, being arranged at the rear end of the linear-motion element, the spiral shape of the flanges corresponding to the spiral shape of the ramps and, a pressure face for transmitting axial forces being arranged at the front end, of the linear-motion element.

2. Axial actuator according to claim 1, wherein the driving device has two axially nested concentric housing halves;
the outer housing half having an end with a central round aperture, a cylindrical wall extending axially from the end to the control element and at least two chamber walls extending radially inward from the wall to the round aperture; and
the inner housing half having a cover ring which extends essentially radially inward from the cylindrical wall to the central round aperture;
a cylindrical wall which extends axially from the cover ring to the aperture; and
at least two chamber walls which extend radially outward from the wall and are twisted relative to the chamber walls of the outer cylindrical wall;
the outer housing half being part of a housing against which the control element, on the rear end of which the inner housing half is arranged in an axially and rotationally fixed manner, is axially supported, resulting in the formation of four chambers, each separated by the chamber walls, between the two axially nested concentric housing halves.

3. Variator for a continuously variable transmission with an axially adjustable variator disk, having an axial actuator according to claim 2
wherein the variator disk is supported at the front end of the linear-motion element on the pressure face and is mounted in an axially displaceable and rotationally fixed manner on the shaft;
wherein the control element and the housing are mounted in an axially fixed manner relative to the shaft;
wherein the shaft is provided with at least two longitudinal pressurized-oil holes, from which respective radial holes extend radially outward in the region of the chambers, thus ending in respective annular slots, in each of which two radial holes, starting from two chambers end.

4. Variator according to claim 3, wherein the variator disk is connected to the shaft by splines.

5. Variator according to claim 3, wherein the variator disk is connected to the shaft by a crossed-roller bearing arrangement.

6. Variator according to claim 5, wherein the crossed-roller bearing arrangement has rolling-contact elements with a diameter A and a height A-X.

7. Variator according to claim 6, wherein the crossed-roller bearing arrangement has rolling-contact elements, all or at least the first and the last rolling-contact elements having a height which is greater than the diameter, e.g., a height A+2Y.

8. Variator according to claim 7, wherein the height A+2Y is achieved by end-face coating of the rolling contact elements.

9. Continuously variable transmission with two variators arranged in a manner complementary to one another in accordance with claim 3, with in each case one variator disk arranged in a fixed manner on the shaft (fixed disk) and one variator disk arranged in a longitudinally displaceable manner on the shaft (loose disk), wherein the control element and the housing of the variator arranged on the output side are preloaded in such a way relative to each other by means of a torsion spring that the loose disk is pressed against the fixed disk owing to the spring force.
